(19) United States
(12) Patent Application Publication
(10) Pub. No.: US 2016/0159982 A1
(43) Pub. Date: Jun. 9, 2016

(54) Articles obtained from a polymer composition, preparation process and uses

(71) Applicant: RHODIA OPERATIONS, Paris (FR)

(72) Inventors: Stéphane JEOL, Cumming, GA (US); Elodie SEIGNOBOS, SAINT GENIS LAVAL (FR); Olivier CHAUBET, Lyon (FR); Michel SORIN, VILLEURBANNE (FR); René ROSSIN, FRANCHEVILLE (FR)

(73) Assignee: RHODIA OPERATIONS, Paris (FR)

(21) Appl. No.: 14/906,363

(22) PCT Filed: Jul. 22, 2014
(86) PCT No.: PCT/EP2014/065730

§ 371 Date: Jan. 20, 2016

(30) Foreign Application Priority Data
Jul. 24, 2013 (FR) 1301774

(51) Int. Cl. C08G 69/26; C08K 7/14; D04H 13/00; C08G 69/46; D01F 6/60; D03D 15/00; C08K 5/06; C08G 69/28

(52) U.S. Cl. CPC C08G 69/26; C08K 5/06; C08K 7/14; C08G 69/28; C08G 69/46; D01F 6/60; D03D 15/00; D04H 13/00

(57) ABSTRACT

Articles obtained from a polymer composition, preparation process and uses The present invention relates to novel articles formed from a polymer composition, the process for preparing same and also the uses of said articles. More specifically, the present invention targets articles that are molded or extruded from a polymer composition in molten form comprising polyamide 10,6.

The present invention relates to novel articles formed from a polymer composition, the process for preparing same and also the uses of said articles. More specifically, the present invention targets articles that are molded or extruded from a polymer composition in molten form comprising polyamide 10,6.

### PRIOR ART

Polyamides, the most common ones being polyamide 6 or polyamide 6,6, are well known for their thermoplastic properties that enable them to be converted in the melt state by extrusion, molding, injection molding or blow molding. These polyamides are used for a large number of applications, and in particular for producing textile yarns, industrial yarns or plastic parts intended for the automotive, electrical or electronics industry (including smartphones, tablet computers and other mobile computing devices). This is because polyamides are plastics known for their good mechanical strength and above all their ability to maintain such properties over time.

Polyamide 6,6 is manufactured from adipic acid and hexamethylenediamine, the salt of which, known as N salt, is polycondensed to the desired degree of polymerization. Other monomers have been widely studied in order to synthesize polyamides other than polyamide 6,6 and in particular to try to improve the dimensional stability of the material in a wet environment. Specifically, even though PA-6,6 has good dry mechanical properties (that is to say when the relative humidity is 0% at 23° C.), its mechanical properties decrease in a wet environment (that is to say when the relative humidity is of the order of 50% at 23° C.) and when the temperature increases. The normal usage conditions of plastic articles are wet conditions, this being even truer in tropical regions where the temperature and humidity are high.

For this purpose, polyamide 6,10, prepared from sebacic acid and hexamethylenediamine, is particularly advantageous since it absorbs less water than polyamide 6,6 (3.3% versus 8.5% at saturation in water at 23° C., according to the Nylon Plastics Handbook by Melvin I. Kohan, Carl Hanser Verlag 1995, page 557 Chapter 13.6, Table 13.26 for PA-6,10 and page 509, chapter 13.2, table 13.6 for PA-6,6). Furthermore, polyamide 6,10 has the advantage of being able to be synthesized in the same industrial equipment as that already in place for polyamide 6,6, thus limiting the investment costs. That said, polyamide 6,10 has a thermal stability that is markedly worse than that of polyamide 6,6, and its mechanical properties in a wet atmosphere are worse than those of PA-6,6. Furthermore, the process for preparing this polymer has a poor productivity since the salt formed between the diamine and the diacid is much less soluble in water than PA-6,6. Very dilute solutions must then be used, resulting in a smaller amount of polymer being obtained for the same initial volume of aqueous salt solution.

Fibers based on polyamide 10,6 have been described in GB 495790. The problem is that such fibers have very poor mechanical properties (tensile strength equal to 0.33 g/per denier, i.e. 33 MPa). Such fibers are not therefore satisfactory in industrial yarn and textile applications.

Today it is important to improve the performances of polyamides intended to be converted into textile yarns, industrial yarns or molded/extruded parts.

Regarding spun articles, it is crucial to have polymer compositions that are easily spinnable, that is to say for which the degree of breakage during spinning is very low and for which the spinning pack pressure does not increase significantly during spinning.

For the textile application, it is especially desirable to provide yarns referred to as “stain-resistant”, that is to say that the yarn does not absorb, or absorbs less of, the dyes (for example food dyes) with which it is in contact. It is also important for the yarn to retain its color over time, and in particular that white textiles prepared from yarns or fibers do not turn gray gradually upon washing.

For industrial yarns, it is important to provide yarns that have a high heat resistance, in particular for airbag applications. Polyamide 6,10 is not suitable in particular for this application since its heat resistance is too low (its melting point being lower than that of PA-6,6). Moreover, the mechanical properties of such yarns must be good and be maintained over time.

For (molded or extruded) plastic parts, what is important is to provide polyamide-based compositions that have a good dimensional stability in a wet environment, mechanical properties close to those of polyamide 6,6 in a wet environment and good aging resistance, for example equivalent to that of polyamide 6,6.

One objective of the present invention is therefore to provide articles formed from a polymer composition in molten form, the aforementioned properties of which, in each of the aforementioned applications, are attained or even improved. Another objective of the present invention is to provide a process for preparing such articles which is optimized in terms of productivity.

### INVENTION

Articles, and a process for preparing such articles, which completely or partly satisfy the aforementioned objectives, have just been highlighted by the applicant.

The present invention thus targets an article formed from a polymer composition in molten form comprising polyamide 10,6, said polyamide 10,6 having a number-average molecular weight of greater than 12 000 g/mol and representing at least 70% by weight relative to the total weight of polymer in said polymer composition.

The invention also relates to a process for preparing the aforementioned articles.

The article formed according to the invention is advantageously a molded or extruded article, in particular having a density between 0.1 and 1.8 (for example a foam has a density of less than 1, and a part comprising glass fibers has a density of greater than 1). It may in particular be an article molded by injection molding, injection blow molding, rotomolding, or by impregnation of a glass fiber or carbon fiber fabric (for example a composite). It may also be an extruded or extruded-blow molded article such as a hollow body, a tube, a strip, a film, a fiber, a yarn or a filament. The term “filament” is understood to mean a monofilament or a multifilament.

Lastly, the invention relates to a woven, nonwoven or knitted part comprising at least one fiber, one yarn or one filament according to the invention.

### DEFINITIONS

The expression “polyamide 10,6” is understood to mean a polymer comprising at least 90 mol % of 10,6 units, that is to say of units obtained by reaction between 1,10-decanediamine and adipic acid, preferably at least 95 mol % of 10,6 units. In other words, the polymer may comprise up to 10 mol % of other units obtained from different comonomers such as other dicarboxylic acids, other diamines, amino acids or lactams. By way of example, mention may be made, as dicarboxylic acid comonomer, of sebacic acid, pimelic acid, azelaic acid, suberic acid, dodecanedioic acid, undecanedioic acid, isophthalic acid and terephthalic acid. By way of example, mention may be made, as diamine comonomer, of hexamethylenediamine, 2-methylpentamethylenediamine, heptamethylenediamine, octamethylenediamine, nonamethylenediamine, undecamethylenediamine, dodecamethylenediamine, isophoronediamine and xylylenediamine. By way of example of amino acid or lactam comonomer, mention may be made of caprolactam.

The expression “article formed” is understood to mean an article obtained from a polymer, by making the polymer adopt a particular predefined and set shape, that has been chosen as a function of the subsequent use of the article. Such forming does not therefore cover a simple bulk cooling of a molten polymer.

The expression “total weight of polymer in said polymer composition” is understood to mean the sum of the weights of each of the polymers present in the composition, including the weight of polyamide 10,6. As a polymer that could be included in this definition, mention will be made, for example, of other polyamides, polyolefins (functionalized with hydroxyl, maleic anhydride, carboxylic acid, sodium carboxylate or zinc carboxylate groups or unfunctionalized), polyesters, polyethers and elastomers.

The term “semicrystalline” is understood to mean a polymer having an amorphous phase and a crystalline phase, for example having a degree of crystallinity of between 1% and 85%. The term “amorphous” is understood to mean a polymer that does not have a crystalline phase detected by thermal analyses (of DSC “differential scanning calorimetry” type) and by x-ray diffraction.

The term “thermoplastic” means a polymer having a temperature above which the material softens and melts without degrading, and below which it becomes hard.

### THE ARTICLES

The article according to the invention is based on a polymer composition that comprises polyamide 10,6 in an amount at least equal to 70% by weight relative to the total weight of polymer in the polymer composition.

Advantageously, the polyamide 10,6 represents at least 80% by weight relative to the total weight of polymer in the polymer composition. Preferably, the polyamide 10,6 represents at least 90% by weight relative to the total weight of polymer in the polymer composition.

According to one particular embodiment of the invention, the polyamide 10,6 is the only polymer present in the polymer composition.

The polyamide 10,6 is obtained by polycondensation of an aqueous solution comprising decanediamine (or 1,10-diaminodecane or 1,10-decanediamine or decamethylenediamine) and adipic acid or a diammonium salt of these two compounds.

Decanediamine and adipic acid are commercially available products. They may or may not be biobased. The term “biobased” is understood to mean that it concerns a material derived from renewable resources. A renewable resource is a natural—animal or plant—resource, the stock of which can be reconstituted over a short period on the human scale. It is in particular necessary for this stock to be able to be renewed as quickly as it is consumed. Unlike materials resulting from fossil materials, renewable raw materials contain a high proportion of ¹⁴C. This characteristic can in particular be determined via one of the methods described in standard ASTM D6866, in particular according to the mass spectrometry method or the liquid scintillation spectrometry method.

According to the invention, the polyamide 10,6 used in the polymer composition has a number-average molecular weight of greater than 12 000 g/mol. Preferably, this number-average molecular weight is greater than 15 000 g/mol. Particularly advantageously, the number-average molecular weight is less than 40 000 g/mol, preferably less than 30 000 g/mol.

The polyamide 10,6 is semicrystalline, having a melting point between 235° C. and 240° C., having a concentration of amine end groups (AEGs) and concentration of acid end groups (CEGs) that are each greater than or equal to 25 meq/kg and less than or equal to 100 meq/kg, having an apparent melt viscosity of between 50 Pa·s and 1500 Pa·s at 280° C. and at a shear rate of 100 s⁻¹.

Preferably, the polyamide 10,6 has a difference (deltaEG) between the AEGs and CEGs, as an absolute value, of less than or equal to 50 meq/kg, preferably of less than or equal to 30 meq/kg.

The composition may in addition comprise at least one heat, light or ultraviolet stabilizer.

According to one advantageous embodiment, the heat, light or ultraviolet stabilizer is selected from: copper compounds such as Cul/Kl mixtures, phosphites, HALS (hindered amines), hindered phenol compounds, polyhydric alcohols, elemental iron, zinc oxide (ZnO) and mixtures thereof in any proportion.

Preferably, the heat, light or ultraviolet stabilizer is selected from Cul/Kl, polyhydric alcohols and elemental iron.

The aforementioned stabilizers are commercially available.

The heat, light or ultraviolet stabilizer may represent between 0.02% and 5% by weight of the total weight of the composition, advantageously between 0.2% and 3% by weight of the total weight of the composition.

The composition according to the invention may in addition comprise fillers and/or additives selected from: reinforcing fillers or bulking fillers, impact modifiers, lubricants, flame retardants, plasticizers, nucleating agents, catalysts, antioxidants, antistatic agents, dyes, mattifying agents, molding aids or other conventional additives.

Among the reinforcing fillers, mention may be made of fibrous reinforcing fillers and non-fibrous reinforcing fillers.

The fibrous reinforcing fillers are advantageously selected from glass fibers, carbon fibers and organic fibers.

The non-fibrous reinforcing fillers are advantageously selected from particulate fillers, lamellar fillers and/or exfoliable or non-exfoliable nanofillers, such as alumina, carbon black, clays, zirconium phosphate, kaolin, calcium carbonate, copper, diatomaceous earths, graphite, mica, silica, titanium dioxide, zeolites, talc, wollastonite, polymeric fillers, such as, for example, dimethacrylate particles, glass beads or glass powder. Preferably, in particular, reinforcing fibers, such as glass fibers, are used.

The composition according to the invention may comprise between 5% and 60% by weight of reinforcing or bulking fillers and preferentially between 10% and 40% by weight, relative to the total weight of the composition.

The expression “impact modifier” is understood to mean a compound capable of modifying the impact strength of the article based on the polymer composition. These impact modifiers preferentially comprise functional groups which react with the polymer. According to the invention, the expression “functional groups which react with the polymer” means groups that are capable of reacting or of interacting chemically with the acid or amine residual functions of the polymer, in particular by covalency, ionic or hydrogen bond interaction or van der Waals bonding. Such reactive groups make it possible to ensure good dispersing of the impact modifiers in the polymer matrix. Examples include anhydride, epoxide, ester, amine and carboxylic acid functions and carboxylate or sulfonate derivatives.

Particularly preferably, the polymer composition used in the articles according to the invention does not comprise any chain limiter. At most, the polymer composition may contain 40 meq/kg of chain limiter, advantageously an amount of less than 20 meq/kg. The expression “chain limiter” is understood to mean any monofunctional compound that has the effect of reducing the molar mass of the polymer by reaction with the amine and/or carboxylic acid functions of the polyamide. Among the possible monofunctional species, mention may be made of monoamines and monocarboxylic acids. Examples of monoamines are hexylamine, dodecylamine and benzylamine. Examples of monocarboxylic acids are acetic acid, propionic acid and benzoic acid.

The composition according to the invention may optionally comprise one or more other polymers in an amount that does not exceed 30% by weight relative to the total weight of polymer in the composition. Such polymers may be, for example, other polyamides, polyesters or polyolefins. These other polymers advantageously represent less than 20% by weight relative to the total weight of polymer in the composition, preferably less than 10% by weight relative to the total weight of polymer in the composition.

Preferably, when another polymer is present, it is PA-6,6, an elastomer or PA-6 in an amount ranging from 3% to 25% by weight.

According to one particular embodiment of the invention, the composition does not comprise another polymer.

### Process for Preparing the Composition

The present invention also relates to a process for preparing an article as defined above, characterized in that it comprises the following steps:
a. in a reactor, adipic acid, 1,10-diaminodecane and water are mixed in order to obtain an aqueous solution of 1,10-decamethylene diammonium adipate salt at a concentration by weight ranging from 30% to 85% by weight,
b. the decamethylene diammonium adipate salt solution resulting from step a. is polymerized by polycondensation,
c. optionally, the polymer obtained in step b. is granulated,
d. optionally, the granules of polymer resulting from step c. are remelted with polymeric or non-polymeric fillers and/or additives,
e. optionally, the polymer composition formed in step d. is granulated,
f. the polymer composition in molten form is shaped.

### Step a

This is a step of salt formation by mixing the diamine and the diacid in water until the desired salt concentration is obtained, that is to say a concentration between 30% and 85% by weight, preferably between 50% and 60% by weight. Such a concentration is considered in the field to be concentrated.

As explained above in the description, it is possible to add to this step up to 10 mol % and preferably up to 5 mol % of comonomers (or the same salt concentration of these comonomers).

When the concentration is between 50% and 60% by weight, the salt solution obtained is homogeneous and stable at ambient temperature (20-25° C.) and atmospheric pressure.

Under the same concentration and temperature conditions, a 6,6 salt and a 6,10 salt precipitate. This presents an advantage for the storage and transport of aqueous 10,6 salt solutions. Indeed, the 10,6 salt solution may for example be stored for several days before undergoing the polymerization step. Industrially, this aspect presents an important economic advantage since it signifies that the concentrated salt solution may also be conveyed from one site to another with a view to its polymerization, without it being necessary to keep it at high temperature while it is being transported. This difficulty is in particular generally encountered for the N salt solution which, at 52%, must be kept at T>50° C. and P=1 bar in order to be able to keep the solution homogenous. For the 6,10 salt, it must be kept at T>80° C. (and P=1 bar) during the storage thereof.

The 1,10-decamethylene diammonium adipate salt is advantageously a stoichiometric salt, that is to say that the ratio between the diacid functions and the diamine functions is between 0.98 and 1.02, preferably between 0.99 and 1.01. A slight imbalance in favor of the acid or amine functions is acceptable, preferably in favor of the acid functions.

The stoichiometry may be controlled, for example, by measuring the pH of the aqueous solution at 20° C. Specifically, the pH of the solution passes through an equivalence point corresponding to perfect stoichiometry between the adipic acid and the 1,10-diaminodecane at 7.85.

### Step b

The polymerization of the decanediamine and adipic acid salt solution is carried out by polycondensation in a reactor.

This polymerization advantageously takes place according to a conventional polymerization process such as that used for polycondensing the N salt to give polyamide 6,6. Such a process generally comprises 4 steps: concentration of the salt solution, distillation under pressure, decompression and finishing.

The first step therefore generally consists in concentrating the 10,6 salt solution to a concentration between 60% and 85% by weight, preferably between 65% and 75% by weight, by heating the aqueous salt solution under a pressure of between 1 and 3 bar, preferably between 2.2 and 2.6 bar. This step is carried out when the salt solution resulting from step a. has a concentration by weight of less than 60%.

Next, in a second step referred to as “distillation under pressure”, the aqueous salt solution is heated, under a pressure advantageously regulated between 10 and 20 bar, more advantageously between 16 and 19 bar, more preferably still at 18.5 bar, until the temperature of the reaction medium reaches between 200° C. and 300° C., advantageously between 220° C. and 275° C., more preferably still 250° C.

In a third step, a decompression down to atmospheric pressure is carried out, accompanied by heating of the reaction medium to a temperature between 230° C. and 300° C., preferably between 260° C. and 280° C., more preferably still to 275° C. Lastly, a finishing step is carried out at atmospheric pressure at a temperature between 240° C. and 300° C., preferably between 260° C. and 280° C., more preferably still at 275° C. for a sufficient duration to achieve the desired average molecular weight.

It is possible to add a catalyst during this step or else branching agents (molecules that have at least three functions that are reactive with respect to the amine and/or carboxylic acid functions). The content is chosen so as to obtain an Mn of greater than or equal to 12 000 g/mol, it is possible to use, for example, bis(hexamethylene)triamine, T4 or aminoisophthalic acid.

If a chain limiter is added, it is advantageously added during step b.

### Step c

Step c. is an optional step of the process in which the polymer obtained in step b. is granulated.

In order to do this, the polymer obtained in step b., which is in molten form, may be cast in the form of rods, cooled at the same time or subsequent to this shaping operation, then formed into granules by chopping up the rods. Alternatively, the polymer may be granulated by an underwater pelletizing system, in particular if it is desired to obtain beads, or by standard pelletizing.

Any granulating means suitable for granulating polyamide 6,6, these means being well known to a person skilled in the art, may be used for granulating the polymer composition resulting from step b.

The granules thus obtained may be post-condensed, for example by solid-state post-condensation (SSPC), by heating under nitrogen at a temperature between 150° C. and 210° C., preferably between 170° C. and 190° C., more preferably still at 180° C. for a sufficient duration to achieve the desired number-average molecular weight.

### Step d

Step d. is an optional step of the process in which the granules obtained in step c. are remelted. This step only exists if step c. exists.

The granules may be remelted in an extruder or by any other means known to a person skilled in the art.

In this step, the temperature is generally between 230° C. and 290° C., preferably between 250 ° C. and 280 ° C.

During this remelting operation, fillers and/or additives may be added.

Other types of polymers, generally in the form of granules, may be added to this remelting step, as long as the amount thereof does not exceed 30% by weight relative to the total weight of polymer in the composition. Such polymers may be, for example, other polyamides, polyesters or polyolefins. These other polymers advantageously represent less than 20% by weight relative to the total weight of polymer in the composition, preferably less than 10% by weight relative to the total weight of polymer in the composition. According to one particular embodiment of the invention, no other polymer is added.

### Step e

Step e. is an optional step of the process in which the polymer composition resulting from step d. is granulated. This step only exists if step d. exists.

### Step f

The shaping of the polymer composition resulting from step b., c., d. or e. may be carried out by various techniques such as:
molding (molding by injection molding, injection blow molding, rotomolding, or molding by impregnation of a glass fiber or carbon fiber fabric (for example in order to produce a composite)),
extrusion (for example in order to produce a strip or a film), extrusion-blow molding (for example in order to produce a hollow body or a tube), or spinning (for example, a fiber, a yarn or a filament).

An additional step of manufacturing a woven, nonwoven or knitted part comprising at least one fiber, one yarn or one filament according to the invention may be envisaged.

### Additives

The heat, light or ultraviolet stabilizer may be introduced before, during or after the polymerization of PA-10,6, in step b., in step d. or in step f. The stabilizer is preferably introduced in step d.

The aforementioned fillers and/or additives may also be introduced into the polymer composition in molten form, that is to say in step d. or in step f. The aforementioned fillers and/or additives may also be introduced during the polymerization, that is to say in step b., advantageously at the end of the finishing step.

When the fillers or additives are mixed with the composition in molten form, the process is performed at more or less high temperature and at more or less high shear force, depending on the nature of the various compounds. The compounds can be introduced simultaneously or successively. Use is generally made of an extrusion mixing device in which the material is heated, then melted and subjected to a shear force, and conveyed. According to particular embodiments, it is possible to prepare preblends, optionally in the melt state, before preparation of the final composition. It is possible, for example, to prepare a preblend in a polymer, for example of PA-10,6, so as to produce a masterbatch.

### Properties

The article formed according to the invention has the following particularly advantageous properties:
for the textile application, the article according to the invention has a water uptake at saturation of less than 3.5%, this means that the textile will have less tendency to absorb the dyes (for example food dyes) with which it is in contact. It will also retain its color better over time, and in particular its white color, which will not turn gray gradually upon washing.
For the industrial yarn application, the article according to the invention has a better heat stability than PA-6,10 since it has a melting point above 235° C. This allows it in particular to be able to be used in airbag applications, unlike PA-6,10.
For the molded/extruded part application, in particular in the automotive, aeronautical, electrical or electronics field, the article according to the invention has, compared to an identical article in which the predominant polymer is PA-6,6:
   a greater dimensional stability in a wet environment (linked to the low water uptake), that is to say that the part will have less tendency to swell over time, and its dimensions will not therefore change), which makes it possible in particular to manufacture smaller parts, for example in the case of motor vehicle door seals,
   mechanical properties in a wet environment that are similar to PA-6,6 (equivalent elastic modulus) and superior to those of PA-6,10.

A specific language is used in the description so as to facilitate understanding of the principle of the invention. Nevertheless, it should be understood that no limitation of the scope of the invention is envisaged by the use of this specific language.

The term “and/or” includes the meanings “and” “or”, and all the other possible combinations of the elements connected to this term.

Other details or advantages of the invention will become more clearly apparent in the light of the examples given below purely by way of indication.

### EXPERIMENTAL SECTION

### Measurement Standards

The melting point (Tₘ) and the crystallization temperature on cooling (T_{c}) of the polymers are determined by differential scanning calorimetry (DSC), using a Perkin Elmer Pyris 1 instrument, at a rate of 10° C./min. The Tₘ and T_{c} values of the polymers are determined at the top of the melting and crystallization peaks. The glass transition temperature (T_{g}) is determined on the same device at a rate of 40° C./min (when possible, it is determined at 10° C./min and specified in the examples). The measurements are taken after melting the polymer formed at T>(Tₘ of the polymer+20° C.).

Thermogravimetric analysis (TGA) is carried out on a Perkin-Elmer TGA7 instrument on a sample of around 10 mg, by heating at 10° C./min with nitrogen flushing up to 600° C. The number-average molecular weight Mn (expressed in g/mol) is calculated by the equation

$$Mn = \frac{2 \; 000 \; 000}{{\sum }_{i} {GT}_{i} - {\sum }_{j} ( {f}_{j} - 2 ) \times {P}_{j}} ,$$

wherein
GTᵢ is the concentration (expressed in meq/kg of polymer) of end groups of type i of the polyamide (amine, carboxylic acid and chain limiter), and
Pⱼ is the concentration of polyfunctional species j (expressed in meq/kg of polymer) of functionality fⱼ (functionality fⱼ=number of reactive functions per polyfunctional species).

When the species i is an amine or a carboxylic acid, the GTᵢ values are determined by potentiometry. When the species i is a chain limiter and for all the polyfunctional species j, GTᵢ and Pⱼ are determined by the ratio between the initial molar amount of the species introduced into the polymerization reactor and the amount by weight of polyamide produced.

In particular, the concentrations of amine end groups (AEGs) and carboxylic acid end groups (CEGs) of the polyamides are determined by potentiometric titration and expressed in meq/kg. The number-average molar mass is determined by the formula Mn=2 000 000/(AEG+CEG), in the absence of chain limiter and of polyfunctional molecules, and it is expressed in g/mol.

### Example 1

### Synthesis of PA-10,6

Before the synthesis of PA-10,6, the pH of a perfectly stoichiometric aqueous solution of adipic acid and of 1,10-diaminodecane is determined in the following manner: a 0.5% aqueous solution of adipic acid regulated at 20° C. is prepared, which is placed in a pH measurement cell, and stirred. A 0.5% aqueous solution of 1,10-diaminodecane regulated at 20° C. is gradually introduced, the system is allowed time to stabilize after each addition (regulation of the temperature at 20° C.) and the pH is measured. The initially acid medium then becomes basic. The pH at 20° C. passes through an equivalence point corresponding to perfect stoichiometry between the adipic acid and the 1,10-diaminodecane at 7.85.

Introduced into a polymerization reactor are 83.3 kg of demineralized water, 49 087 g of 1,10-diaminodecane from the company Feixiang having the reference Fentamine HP-102 and 6.4 g of an antifoaming agent. The reactor is heated at 65° C. and 41 392 g of adipic acid from the company Rhodia Solvay are gradually introduced. The temperature then reaches 95° C. (exothermic reaction). A sample is withdrawn from the aqueous salt solution which is cooled to 20° C. and then diluted to 10% by weight in order to measure its pH at 20° C.: 7.66 (slight imbalance in favor of the acid functions). Surprisingly, it is observed that a sample of 10,6 salt at 52% by weight in water is perfectly homogeneous (no precipitation of the salt) at 20° C. Under the same concentration and temperature conditions, a 6,6 salt and a 6,10 salt precipitate. This presents an advantage for the storage and transport of aqueous 10,6 salt solutions.

The reactor containing the aqueous solution is purged with nitrogen 4 times, then the polymerization is carried out according to a process identical to that of the polymerization of polyamide 6,6: concentration of the 10,6 salt to 70% by weight by heating the aqueous salt solution under 2.4 bar, heating of the 70% by weight salt under a pressure regulated at 18.5 bar until the temperature of the reaction medium reaches 250° C. (distillation under pressure phase), decompression down to atmospheric pressure accompanied by heating of the reaction medium to 275° C. and finishing at atmospheric pressure at 275° C. for 27 min.

The PA-10,6 polymer obtained is cast in the form of rods, cooled, and formed into granules by chopping up the rods.

The PA-10,6 polymer obtained has the following characteristics: CEG =80 meq/kg, AEG=51 meq/kg, i.e. Mn =15 270 g/mol. The difference CEG-AEG =29 meq/kg is also calculated. The polymer is semicrystalline and has the following thermal characteristics: T_{c}=203° C., Tₘ=239° C., T_{g}=63° C. (measurement carried out at 40° C./min).

### Example 2

### Spinning of PA-10,6 and Comparison with the Spinning of PA-6,10

For comparison, a PA-6,10 purchased from the company Nexis having a reference 7030 is used. Analysis of the end groups indicates CEG=70 meq/kg and AEG=47 meq/kg, i.e. a positive end group difference CEG-AEG=23 meq/kg, therefore comparable to that of the PA-10,6 from example 1.

The granules of PA-10,6 and PA-6,10 are dried in order to obtain a concentration in water of 800 ppm before the spinning test. A yarn is produced on a spinning unit with the following process conditions: temperature profile 270° C./275° C./275° C./280° C./285° C., throughput 1 kg/h, filter pack through 10 pm metallic filter 48 mm in diameter, spinneret with 14 holes of 0.33×2D, winder at a speed of 450 m/min and 1% Delion F5103 size on yarn. During the spinning, the pressure of the molten material at the filter pack is measured.

With the PA-10,6 from example 1, no spinning problems are encountered throughout the entire duration of the test (8 h). The pressure at the filter pack changes from 60 bar to only 85 bar (+3.1 bar per hour on average) at the end of 8 hours: the spinning takes place in a manner judged to be very stable.

With the Nexis 7030 PA-6,10, the pressure at the pack changes from 68 bar to 140 bar at the end of 8 hours (+9 bar per hour). The spinning is judged to be less stable than with the PA-10,6 from example 1.

An analysis of the amount of water absorbed by the PA-10,6 yarns and PA-6,10 yarns is carried out by weighing in a climatic chamber regulated at 65% relative humidity at 20° C. over 24 h. The amount of water absorbed is calculated by the ratio of (the difference in the weight of the yarn after 24 h in the climatic chamber and the weight of the yarn before being introduced into the climatic chamber) to the weight of the yarn before being introduced into the climatic chamber. PA-10,6 takes up 2.8% water under these conditions and PA-6,10 takes up 3.3% water, which represents an advantage for PA-10,6.

A drawing test of the PA-10,6 yarn up to a draw ratio of 3.8 takes place without any problems.

### Example 3

### Production of Injection-Molded Parts and Measurement of Properties

The polyamide PA-10,6 from example 1, a PA-6,10 sold by the company Radici under the reference Radipol DC45D and a PA-6,6 Technyl® A216 Natural from Rhodia-Solvay are injection molded in the form of IS0527/1A standard test specimens (4 mm thick multipurpose test specimens) and sheets with dimensions of 100×100×3.4mm³: in a mold regulated at 85° C. After the injection molding, the test specimens and sheets are placed in a heat-sealed aluminized envelope to prevent any water uptake before the analyses.

The dynamic mechanical analysis (3-point bending test) at temperature, from −100° C. to 100° C. every 2° C. at a frequency of 1 Hz and a strain of 0.05%, is carried out on IS0527/1A test specimens using a TA Instruments RSA3 rheometer. The alpha transition temperature of the PA-6,10 is determined at 58° C., that of the PA-10,6 at 68° C. and that of the PA-6,6 at 78° C. The PA-10,6 has a dry-state _{Taloa} that is 10° C. above that of the PA-6,10.

The elastic modulus at 23° C. of the PA-6,10 measured at 2300 MPa, that of the PA-10,6 at 2650 MPa and that of the PA-6,6 at 2670 MPa.

After conditioning at 50% RH and 23° C., it is observed that the T_{g} of the PA-10,6 in a wet environment is similar to that of the PA-6,6.

The ISO527/1A tensile mechanical properties at 23° C. under dry conditions and after conditioning at 50% relative humidity and 23° C. are collated in table 1. The PA-10,6 is therefore more rigid than the PA-6,10 regardless of the level of relative humidity. It has, in the conditioned state, mechanical properties very close to those of the PA-6,6 in the conditioned state (actual usage conditions) while having a greater dimensional stability due to its low water uptake.

TABLE 1

| | | | | Tensile | Loading | tensile |
|---|---|---|---|---|---|---|
| | Tensile | Loading | tensile | modulus | stress | strength |
| | modulus | stress | strength | after cond. | after cond. | after cond. |
| | (MPa) | (MPa) | (MPa) | (MPa) | (MPa) | (MPa) |
| PA- | 2220 | 65 | 39 | 1110 | 47 | 53 |
| 6,10 | | | | | | |
| PA- | 2320 | 62 | 41 | 1230 | 51 | 40 |
| 10,6 | | | | | | |
| PA- | 3000 | 85 | 55 | 1400 | 60 | 40 |
| 6,6 | | | | | | |

The water uptake by immersion is carried out in water at 60° C. until saturation, via regular weighings. When the weight no longer changes, the water uptake is determined by the ratio of (the difference in the weight of the sheet at the end of the water absorption test and the weight of the sheet before being placed in water) to the weight of the sheet before being placed in water. Surprisingly, the sheets of PA-10,6 take up only 3.4% water versus 4.5% for the sheets of PA-6,10 whereas PA-10,6 and PA-6,10 have the same [—CH₂]/[-amide-] ratio which normally makes it possible to predict the water uptake of PA-X,Y type polyamides. As for the PA-6,6, it takes up 8.5% water.

The parts molded from PA-10,6 therefore have a better dimensional stability than the PA-6,10 while having mechanical properties in a conditioned medium (normal usage conditions of polyamide parts) similar to those of PA-6,6.

### Example 4

### Solid-State Post-Condensation on PA-10,6 from Example 1, Measurement of the Rheological Profile and Preparation of Monofilaments

The solid-state post-condensation (SSPC) of the PA-10,6 from example 1 is carried out by heating under nitrogen at 180° C. for 8 hours. Measurement of the end group concentrations indicates: CEG=57 meq/kg, AEG =27 meq/kg, i.e. Mn=23 800 g/mol and CEG-AEG=30 meq/kg. Retaining the difference between the acid and amine end groups before and after post-condensation shows that there were no secondary reactions but only the polycondensation reaction.

The rheological profile at 280° C. of the PA-10,6 from example 1 and of the PA-10,6 thus post-condensed is determined on a Gottfert 2002 capillary rheometer. The PA-10,6 and the post-condensed PA-10,6 are conditioned so as to respectively contain 1100 ppm of water and 350 ppm of water before the analysis of their rheological profile. Under these conditions, no change in the melt viscosity at 280° C. and 200 s⁻¹ is observed over a duration of 10 min. Therefore the rheological profile is carried out at 280° C. using these granules (table 2).

TABLE 2

| Shear rate | η in Pa · s PA-10,6 - | η in Pa · s PA-10,6 |
|---|---|---|
| in s⁻¹ | example 1 | post-condensed |
| 5000 | 56 ± 10% | 107 ± 10% |
| 2500 | 80 ± 10% | 172 ± 10% |
| 1000 | 119 ± 10% | 296 ± 10% |
| 500 | 151 ± 10% | 428 ± 10% |
| 250 | 181 ± 10% | 596 ± 10% |
| 100 | 216 ± 10% | 900 ± 10% |
| 50 | 236 ± 10% | 1189 ± 10% |

Monofilaments of these two PA-10,6 are prepared.

The granules of PA-10,6 from examples 2 and 4 are dried in an oven in order to obtain water concentrations of 800 to 1000 ppm before the production of the monofilament on the spinning-drawing line according to the following continuous process: The polymer is melted in a single-screw extruder comprising 3 heating zones which directly feeds a spinneret comprising a single hole having a diameter of 1 mm or 2 mm depending on the tests. The molten yarn is cooled naturally and taken up in air by a set of 7 unheated delivery rollers all rotating at the same speed then is drawn in a heating oven without contact by a set of unheated rollers rotating at a faster speed. The ratio between the speed of the drawing system and the speed of the delivery system gives the draw ratio. The monofilament is conveyed to the winder and wound onto a bobbin. A natural shrinkage of the yarn occurs between the drawing system and the bobbin, it depends on the nature of the polymer and on the level of stress to which the monofilament is subjected.

The operating conditions are given in table 3.

TABLE 3

| | Extruder: | Spinneret | | | | | Diameter of the |
|---|---|---|---|---|---|---|---|
| | T° C. of the | diameter | Screw speed | Speed of the | T° C. in | Draw | yarn on the |
| | heating bands | (mm) | (rpm) | take-up system | the oven | ratio | bobbin (μm) |
| PA-10,6 | 255/260/270 | 1 | 10 | 9 | 150 | 4.5 | 190 |
| PA-10,6 | 270/265/265 | 2 | 20 | 10 | 150 | 4.5 | 270 |
| PA-10,6 | 270/275/275 | 2 | 20 | 10 | 200 | 4.0 | 330 |
| SSPC | | | | | | | |
| PA-10,6 | 270/275/275 | 2 | 40 | 9 | 200 | 3.5 | 480 |
| SSPC | | | | | | | |

### Example 5

### Production of Formulations that are Resistant to Thermal Oxidation

Before extrusion, the granules of polyamide PA-10,6 from example 1 and of Radipol® DC45D polyamide PA-6,10 from the company Radici were dried to a water content of less than 1500 ppm. Formulations were prepared by melt-blending various components and additives in a Werner & Pfleiderer ZSK 40 twin-screw corotating extruder operating at 40 kg/h and at a speed of 280 rpm. The temperature settings in the 8 zones were respectively: 250° C., 255° C., 260° C., 260° C., 265° C., 270° C., 275° C., 280° C. All the components in the formulation were added at the start of the extruder. The rod having exited the extruder was cooled in a water tank and chopped into the form of granules using a granulator and the granules were packaged in a heat-sealed bag. Before being injection molded, the granules were dried so as to obtain a moisture content of less than 1500 ppm.

The formulations obtained were the following:
Comparative example C1: polyamide PA-6,10 +35% by weight of glass fibers (OCV 983 from Owens Corning Vetrotex)+2% by weight of heat stabilizer additive dipentaerythritol (DPE) from the company Sigma-Aldrich (technical grade)+0.3% lubricant ethylene bis(stearamide) (EBS).

### Example 5

### polyamide PA-10,6 from Example 1 +35% by Weight Of Glass Fibers+2% by weight of DPE+0.3% by weight of EBS.

The prepared formulations were injected onto a Demag 50T press at 280° C. with a mold temperature of 80° C., in the form of 4 mm thick multipurpose test specimens, in order to characterize the tensile mechanical properties (tensile modulus, tensile strength, strain at break—average obtained over 5 samples) according to standard ISO 527/1A at 23° C. before and after thermal aging in air.

The thermal aging ventilated in air was carried out by placing the test specimens in a Toyoseiki 30SS oven regulated at 210° C. At various aging times, test specimens were removed from the oven, cooled to ambient temperature and placed in heat-sealed bags in order to prevent them from taking up any moisture before evaluation of their mechanical properties.

The retention of tensile strength at a given aging time is then defined relative to these same properties before aging. The retention is thus defined as a percentage.

The formulations and properties are collated in table 4 below:

TABLE 4

| | C1 | 5 |
|---|---|---|
| PA-6,10 (% by weight) | 62.7 | — |
| PA-10,6 (Example 1) (% by weight) | — | 62.7 |
| OCV 983 glass fibers (%) | 35.0 | 35.0 |
| DPE (%) | 2 | 2 |
| EBS (%) | 0.3% | 0.3% |
| Before aging | | |
| tensile strength (MPa) | 162.4 | 175.4 |
| Young's Modulus (MPa) | 10 269 | 10 212 |
| Strain at break (%) | 3.97 | 3.93 |
| After aging for 500 h at 210° C. | | |
| tensile strength (MPa) | 186.1 | 193.9 |
| Young's Modulus (MPa) | 11 288 | 10 595 |
| Strain at break (%) | 2.80 | 3.42 |
| Retention of tensile strength (%) | 114.6 | 110.6 |

It appears that the formulations based on PA-10,6 and on PA-6,10 stand up well after a high-temperature aging of 210° C. for 500 h but the level of tensile strength of the formulation based on PA-10,6 is higher, before and after aging, than that of the formulation based on PA-6,10. The formulation based on PA-10,6 therefore has a significant advantage since it is this level of initial strength and strength after aging that is used in the design of motor vehicle parts subjected to these temperatures.

1. An article formed from a molten polymer composition, said composition comprising, relative to the total weight of polymer in said polymer composition, at least 70% by weight of polyamide 10,6 having a number-average molecular weight of greater than 12,000 g/mol.

2. The article as claimed in claim 1, wherein the number-average molecular weight, Mn, (expressed in g/mol), of the polyamide 10,6 is calculated by the equation:
$$Mn = \frac{2 \; 000 \; 000}{{\sum }_{i} {GT}_{i} - {\sum }_{j} ( {f}_{j} - 2 ) \times {P}_{j}} ,$$
wherein GTᵢ is the concentration (expressed in meq/kg of polymer) of end groups of type i of the polyamide, and Pⱼ is the concentration of polyfunctional species j (expressed in meq/kg of polyamide), fⱼ is equal to the number of reactive functions per polyfunctional species j, and wherein the GTᵢ and Pⱼ are determined, depending on the nature of the species i and j by the ratio between the initial molar amount of the species introduced into the polymerization and the amount by weight of polyamide produced or, if species i is an amine or a carboxylic acid, by potentiometry.

3. The article as claimed in claim 1 wherein the polyamide 10,6 is the only polymer present in the polymer composition.

4. The article as claimed in claim 1, wherein said polyamide 10,6 has a number-average molecular weight of greater than 15,000 g/mol.

5. The article as claimed in claim 1, wherein the polymer composition comprises at least one heat, light or ultraviolet stabilizer.

6. The article as claimed in claim 5, wherein the heat, light or ultraviolet stabilizer is selected from: copper compounds such as Cul/Kl mixtures, phosphites, hindered amines, hindered phenol compounds, polyhydric alcohols, elemental iron, zinc oxide and mixtures thereof in any proportion.

7. The article as claimed in claim 1, wherein the heat, light or ultraviolet stabilizer represents between 0.02% and 5% by weight of the total weight of the polymer composition.

8. The article as claimed in claim 1, wherein the article is a molded or extruded article.

9. The article as claimed in claim 8, wherein the article is an article molded by injection molding, injection blow molding, rotomolding, or by impregnation of a glass fiber or carbon fiber fabric.

10. The article as claimed in claim 8, wherein the article is an extruded or extruded-blow molded article selected from the group consisting of: a hollow body, a tube, a strip, a film, a fiber, a yarn, and a filament.

11. A woven, nonwoven or knitted part comprising at least one fiber, one yarn or one filament as claimed in claim 10.

12. A process for preparing an article as defined in claim 1, comprising:
a. mixing, adipic acid, 1,10-diaminodecane and water to obtain an aqueous solution of 1,10-decamethylene diammonium adipate salt at a concentration of from 30% to 85% by weight,
b. polymerizing the decamethylene diammonium adipate salt solution resulting from step a by polycondensation,
c. optionally, granulating the polymer obtained in step b
d. optionally, remelting granules of polymer resulting from step c with polymeric or non-polymeric fillers and/or additives,
e. optionally, granulating the polymer composition formed in step d and
f. shaping the polymer composition in molten form.

13. The process as claimed in claim 12, wherein the aqueous solution of 1,10-decamethylene diammonium adipate salt has a concentration of between 50% and 60% by weight.
